(19) United States
(12) Patent Application Publication
(10) Pub. No.: US 2011/0102417 A1
(43) Pub. Date: May 5, 2011

(54) ORGANIC LIGHT EMITTING DIODE DISPLAY, DRIVING METHOD THEREFOR AND PIXEL UNIT THEREOF

(76) Inventors: Chih-Chiang Chen, Hsichih (TW); Yu-Li Chen, Hsichih (TW)

(21) Appl. No.: 12/770,051

(22) Filed: Apr. 29, 2010

(30) Foreign Application Priority Data
Oct. 30, 2009 (TW) 098137003

(51) Int. Cl. G06F 3/038; G09G 3/30

(52) U.S. Cl. 345/214; 345/80

(57) ABSTRACT

The present invention discloses an organic light emitting diode display, a driving method therefor and a pixel unit thereof. The organic light emitting diode display comprises a pixel array comprising a plurality of organic light emitting diode (OLED) pixel groups of different colors, such as red, green and blue. The organic light emitting diode display can determine the ratio of shortened light emission intervals of OLED pixel groups of a specific color based on the color distribution of an image, thereby effectively prolonging the life of the OLEDs of a specific color. In one embodiment, the pixel unit of the organic light emitting diode display comprises an OLED, a switch and a drive circuit. The switch controls whether or not the current outputted from the drive circuit flows to the OLED so as to achieve the effect of the above-mentioned shortened emission interval.

### CROSS REFERENCE TO RELATED APPLICATIONS

This application claims priority to Taiwan Patent Application No. 098137003 filed on Oct. 30, 2009, the entirety of which is herein incorporated by reference.

### FIELD OF THE INVENTION

The present invention relates to an organic light emitting diode display, and more particularly to an OLED display capable of shortening the light emission time of OLEDs of a specific color.

### BACKGROUND OF THE INVENTION

With the development of information technology, more and more attention has been paid to various flat panel display technologies, one of which is the organic light emitting diode (OLED) technology. The organic light emitting diode technology is a self-luminous technology. Therefore, an OLED requires no backlight, and has a wide viewing angle, good color contrast, a high response speed, a low cost and other advantages. Additionally, such an OLED can be fabricated on a flexible substrate, so it is a developmental display technology in the future. In an OLED display, each pixel is comprised of multiple OLEDs of different colors. After the pixel receives a driving signal, the OLEDs of different colors are controlled to emit light with corresponding intensities. Then, an appropriate color is produced by light hybrid.

OLED materials are classified into two categories: small molecule OLEDs (SMOLEDs) and polymer light-emitting diodes. They are stacked in multiple layers to form a light emitting unit. Referring to FIG. 1, there is depicted a schematic view of a basic structure of a conventional OLED. In this figure, the structure of the OLED comprises a substrate 11, an anode 12, a hole transporting layer (HTL) 13, an emission layer (EML) 14, an electron transporting layer (ETL) 15 and a cathode 16. Organic materials such as the hole transporting layer 13, the emission layer 14, an electron transporting layer 15 are sandwiched between the anode 12 and the cathode 16 to form a sandwich structure. When an appropriate voltage 17 is applied, holes injected from the anode 12 and electrons injected from the cathode 15 recombine in the emission layer 14, which excite the organic materials in the emission layer 14 to emit light 18. The luminous quantity of the OLED is proportional to the current flowing thereinto.

The luminous principle of an OLED is that electrons and holes are driven to recombine in the organic materials to excite light emission. Thus, the luminescent materials will age and degrade with the light emission time. Besides, the higher the luminous intensity per unit time is, the faster the luminescent materials age and degrade, referred as to differential aging. Moreover, if an OLED display tends to display images of a specific color for a long time, it is easy for the OLEDs of the specific color in the display to degrade faster. As a result, the display function of the entire OLED display will be lost or seriously influenced. Therefore, how to effectively prolong the service life of an OLED display is a problem to be urgently solved.

### SUMMARY OF THE INVENTION

In view of the above-mentioned problems of the prior art, an object of the present invention is to provide an organic light emitting diode display, a driving method therefor and a pixel unit thereof, so as to prolong the service life of the organic light emitting diode displays.

According to the object of the present invention, there is provided an organic light emitting diode display apparatus comprising a pixel array, a signal processing unit, a scan driving unit, a data driving unit and a light emission control unit. The pixel array comprises a plurality of pixel units each having an organic light emitting diode, and the plurality of pixel units are divided into a plurality of pixel groups. The signal processing unit receives an image and generates a plurality of data signals respectively corresponding to the plurality of pixel units in accordance with the image, and determines a plurality of light emission parameters respectively corresponding to the plurality of pixel groups. The scan driving unit generates a plurality of scanning signals in accordance with the plurality of light emission parameters and a frame interval and drives the pixel array in accordance with the plurality of scanning signals. The data driving unit drives the plurality of pixel units in accordance with the plurality of data signals. The light emission control unit generates a plurality of control signals in accordance with the plurality of light emission parameters to control the respective light emission time of the plurality of pixel groups within the frame interval.

The plurality of pixel groups display different colors, respectively.

The plurality of scanning signals correspond to the plurality of pixel columns or the plurality of pixel rows of the pixel array, respectively.

Each scanning signal includes a plurality of pulses, and the frame interval is between two adjacent pulses.

Each light emission parameter is a ratio value of a light emission interval or a non-light emission interval of the pixel unit within the frame interval.

The signal processing unit analyzes a gray scale distribution of the image corresponding to the plurality of pixel groups, and determines light emission parameters corresponding to the plurality of pixel groups in accordance with the gray scale distribution.

According to the object of the present invention, there is further provided a driving method for an organic light emitting diode display. A pixel unit of the organic light emitting diode display has an organic light emitting diode and a drive circuit. The drive circuit is connected to the organic light emitting diode. The driving method comprises the following steps of: receiving a data signal and a scanning signal including a frame interval by the drive circuit; generating within the frame interval a current corresponding to the data signal and flowing through the organic light emitting diode in accordance with the scanning signal by the drive circuit; receiving a control signal which defines a first interval and a second interval from the frame interval; controlling the current in accordance with the control signal so that the luminous intensity of the organic light emitting diode in the second interval being lower than the luminous intensity of the organic light emitting diode in the first interval.

The driving method further comprises analyzing an image received by the organic light emitting diode display, and determining a ratio value of the first interval or the second interval in accordance with the analytical result.

When the number of the pixel units is plural and the pixel units are divided into a plurality of pixel groups, the pixel unit of the same pixel groups corresponds to the same ratio value of the first interval or the second interval.

The scanning signal includes a plurality of pulses, and the frame interval is between two adjacent pulses.

When the number of the pixel units is plural and the pixel units form a pixel array, the second interval corresponding to the plurality of pixel rows or the plurality of pixel columns of the pixel array is synchronous.

According to the object of the present invention, there is further provided a pixel unit comprising an organic light emitting diode, a switch and a drive circuit. The drive circuit is coupled to the organic light emitting diode and the switch, and receives a scanning signal including a frame interval and a data signal. The drive circuit generates within the frame interval a current corresponding to the data signal and flowing to the organic light emitting diode. The switch controls the current flowing toward the organic light emitting diode only in some intervals of the light emission interval.

The drive circuit comprises a first transistor, a second transistor and a capacitor. The source of the first transistor is connected to a data line for receiving the data signal. The gate of the first transistor is connected to a scanning line for receiving the scanning signal. The source of the second transistor is connected to the anode of the organic light emitting diode. The gate of the second transistor is connected to the drain of the first transistor. Both ends of the capacitor are respectively connected to the gate and the drain of the second transistor. Both ends of the switch are connected to the drain of the second transistor and a first voltage source.

The drive circuit comprises a first transistor, a second transistor and a capacitor. The source of the first transistor is connected to a data line for receiving the data signal. The gate of the first transistor is connected to a scanning line for receiving the scanning signal. The source of the second transistor is connected to the anode of the organic light emitting diode. The gate of the second transistor is connected to the drain of the first transistor. The drain of the second transistor is connected to a first voltage source. Both ends of the capacitor are respectively connected to the gate of the second transistor and the first voltage source. Both ends of the switch are connected to the source of the second transistor and a second voltage source.

The drive circuit further comprises a current duplication circuit for duplicating a current flowing through the data line.

As described above, the organic light emitting diode display, the driving method therefor and the pixel unit thereof according to the present invention may have the following advantages: the organic light emitting diode display, the driving method therefor and the pixel unit thereof can determine the ratio of shortened light emission intervals of OLED pixel groups of a specific color based on the color distribution of an image, thereby effectively prolonging the life of the OLEDs of a specific color.

### BRIEF DESCRIPTION OF THE DRAWINGS

FIG. 1 depicts a schematic view of a basic structure of a conventional OLED;

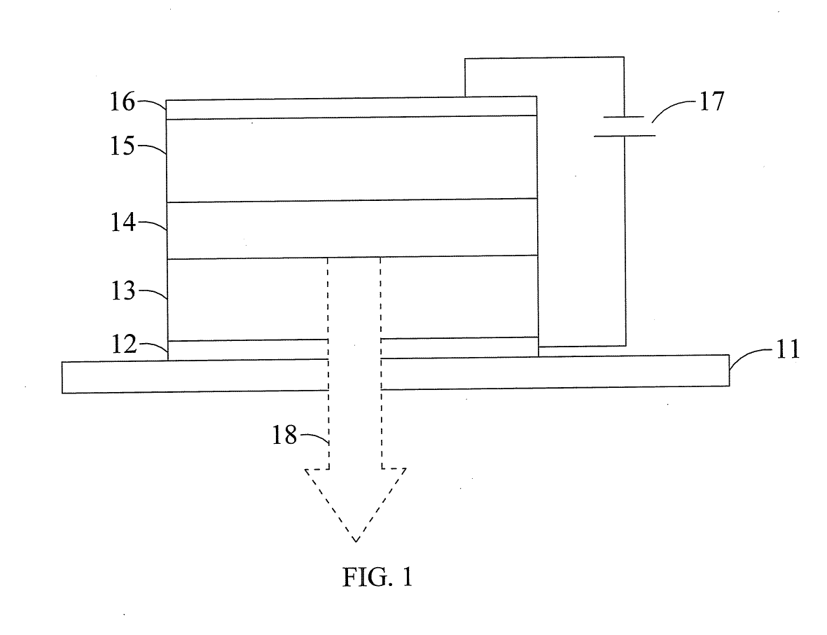

FIG. 2 depicts a circuit diagram of a first embodiment of a pixel driving circuit of an organic light emitting diode display according to the present invention;

FIG. 3 depicts a first signal timing sequence diagram of a pixel driving circuit of an organic light emitting diode according to the present invention;

FIG. 4 depicts a circuit diagram of a second embodiment of a pixel driving circuit of an organic light emitting diode according to the present invention;

FIG. 5 depicts a second signal timing sequence diagram of a pixel driving circuit of an organic light emitting diode according to the present invention;

FIG. 6 depicts a third signal timing sequence diagram of a pixel driving circuit of an organic light emitting diode according to the present invention;

FIG. 7 depicts a circuit diagram of a third embodiment of a pixel driving circuit of an organic light emitting diode according to the present invention;

FIG. 8 depicts a block diagram illustrating an organic light emitting diode display apparatus according to the present invention;

FIG. 9 depicts a partial schematic view of a circuit of an organic light emitting diode display apparatus according to the present invention;

FIG. 10 depicts a signal timing sequence diagram of an embodiment of an organic light emitting diode display apparatus according to the present invention;

FIG. 11 depicts a schematic circuit diagram of a second embodiment of an organic light emitting diode display apparatus according to the present invention;

FIG. 12 depicts a schematic circuit diagram of a third embodiment of an organic light emitting diode display apparatus according to the present invention;

FIG. 13 depicts a signal timing sequence diagram of another embodiment of an organic light emitting diode display apparatus according to the present invention;

FIG. 14 depicts gray level histograms for the red, green and blue colors of an image;

FIG. 15 depicts a flow chart illustrating a driving method for an organic light emitting diode display according to the present invention; and

FIG. 16 depicts a flow chart illustrating the implementation of a driving method for an organic light emitting diode display according to the present invention.

### DETAILED DESCRIPTION OF THE PREFERRED EMBODIMENTS

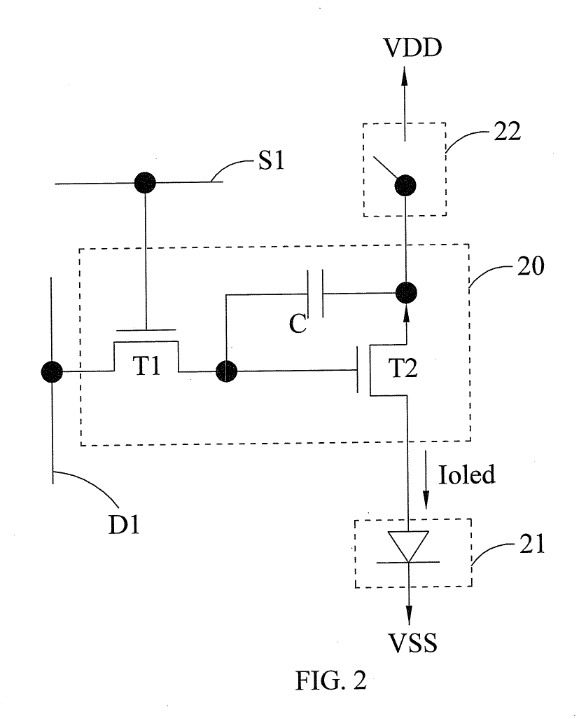

Referring to FIG. 2, there is illustrated a circuit diagram of a first embodiment of a pixel driving circuit of an organic light emitting diode display according to the present invention. In this figure, the pixel driving circuit comprises a drive circuit 20, an organic light emitting diode (OLED) 21 and a switch 22. The drive circuit 20 comprises a transistor T1, a transistor T2 and a capacitor C. The source of the transistor T1 is connected to a data line D1 for receiving a data signal DATA. The gate of the transistor T1 is connected to a scanning line S1 for receiving a scanning signal SCAN. The source of the transistor T2 is connected to the anode of the OLED 21. The drain of the transistor T2 is connected to a voltage source VDD. The gate of the transistor T2 is connected to the drain of the transistor T1. One end of the capacitor C is connected to the gate of the transistor T2, and the other end of the capacitor is connected to the switch and the voltage source VDD.

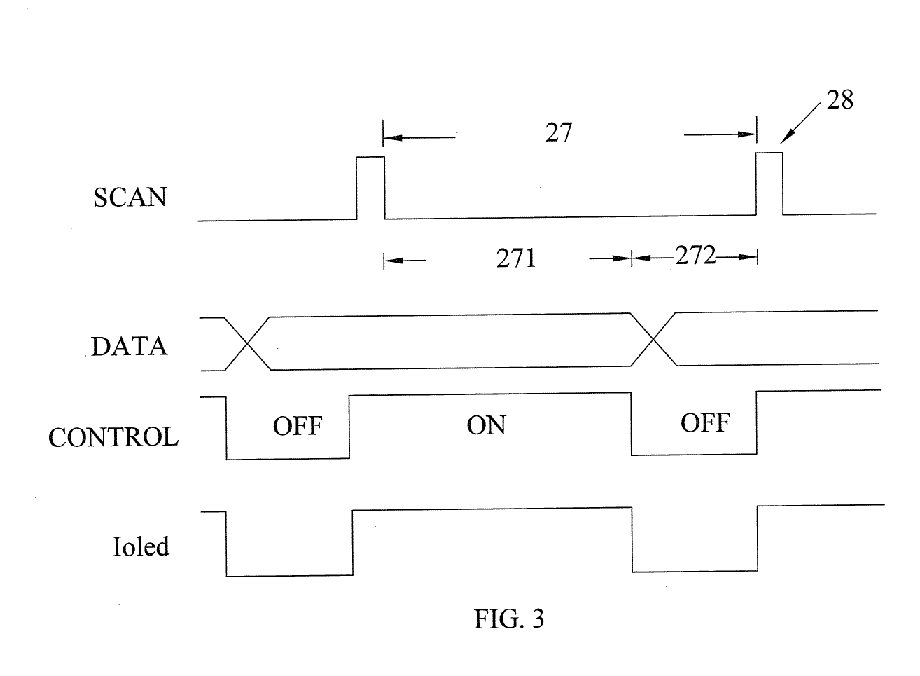

Referring to FIG. 3, there is illustrated a signal timing sequence diagram of a pixel driving circuit of an organic light emitting diode according to the present invention. In this figure, the scanning signal S1 has multiple pulses 28, and two adjacent pulses 28 define a frame interval 27. When the gate of the transistor T1 receives the pulse signal 28, the voltage at the gate of the transistor T1 is shifted from a low potential to a high potential and the transistor T1 is turned on to provide a closed path between the source and the drain of the transistor T1 so that one end of the capacitor C can receive the data signal DATA for being charged. When the voltage at the gate of the transistor T1 is shifted from a high potential to a low potential, the transistor T1 is turned off to provide an open path between the source and the drain of the transistor T1. The voltage between both ends of the capacitor C can be used for controlling the magnitude of a current I_{oled} flowing from the source of the transistor T2 to the OLED 21. The luminous intensity of the OLED 21 is associated with the magnitude of the input current. As a result, the aforementioned procedure can control the OLED 21 and enable the luminous intensity of the OLED 21 to correspond to the data signal DATA.

A plurality of the above-described pixel units are combined to form a pixel array which can display an image. In the prior art, the OLED 21 emits light continuously within the frame interval 27. In order to effectively prolong the life of the OLED 21 to prevent the display function of the entire OLED display from being lost or seriously influenced due to the degradation of OLEDs 21 of a specific color in a pixel array, the OLED 21 can be controlled to emit light only during some time period in the frame interval 27. In this embodiment, the switch 22 is controlled by the control signal CONTROL illustrated in FIG. 3. When the control signal CONTROL is at a high potential, the switch 22 is turned on and the voltage source VDD can supply a current I_{oled} to the OLED 21; on the contrary, when the control signal CONTROL is at a low potential, the switch 22 is turned off and the voltage source VDD cannot supply a current I_{oled} to the OLED 21 so that the OLED 21 stops emitting light. Hence, the OLED 21 emits light during the interval 271 within the frame interval 27 and stops emitting light during the interval 272. By this way, the light emission time of the OLED within the frame interval can be effectively controlled without changing the original structure of the pixel unit.

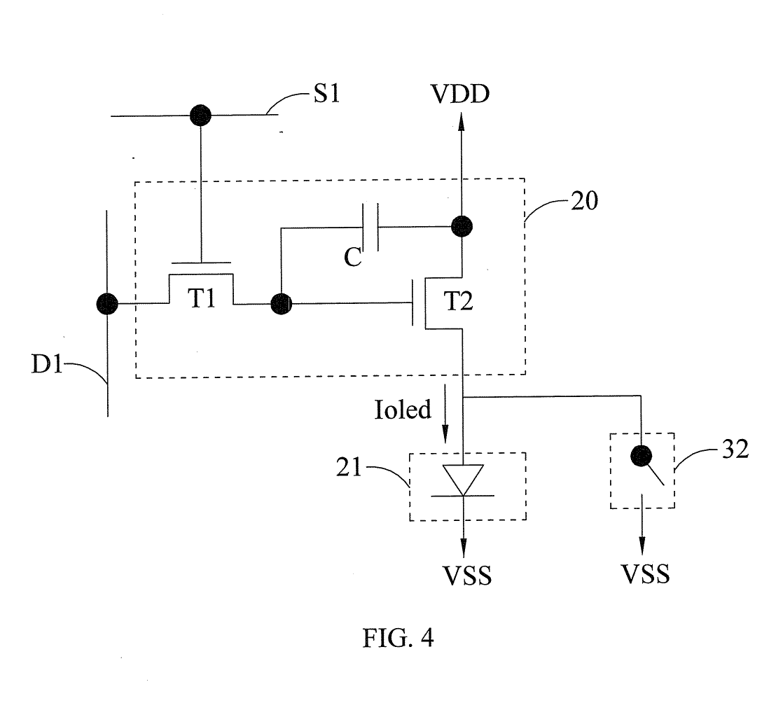

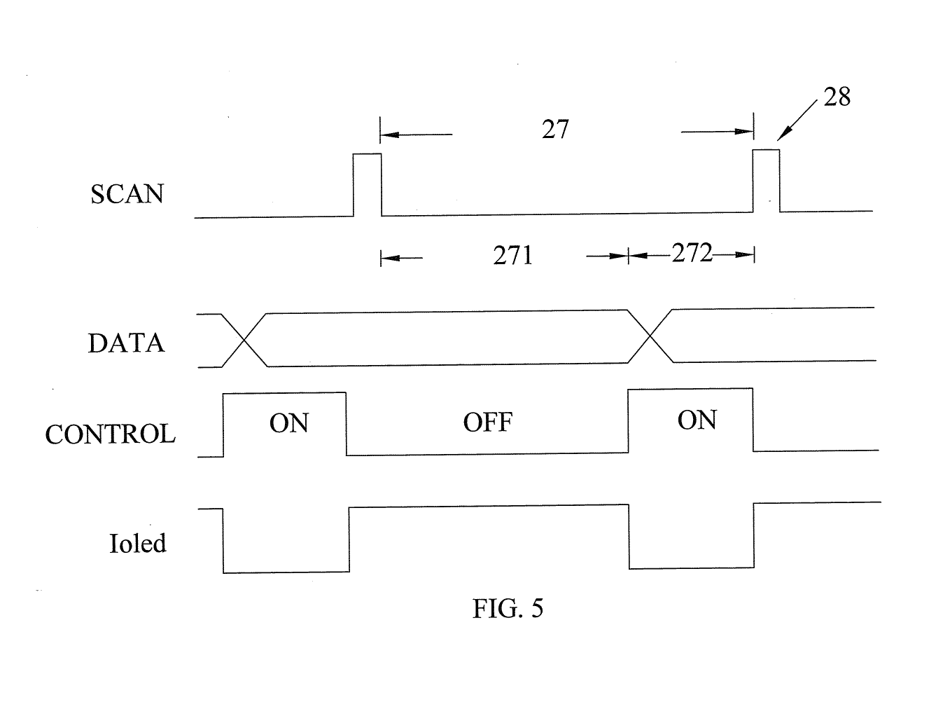

Referring to FIG. 4, there is illustrated a circuit diagram of a second embodiment of a pixel driving circuit of an organic light emitting diode according to the present invention. In this figure, the difference between the second embodiment and the first embodiment is that the switch 32 is connected to the anode of the OLED 21 but not disposed between the voltage source VDD and the transistor T2. The switch 32 is controlled by the control signal CONTROL illustrated in FIG. 5. When the control signal CONTROL is at a high potential, the switch 32 is turned on to form a low resistance path which is connected in parallel with the OLED, so that the circuit flows toward this path but toward the OLED 21. Thus, the voltage source VDD cannot supply a current I_{oled} to the OLED 21, and the OLED 21 stops emitting light.

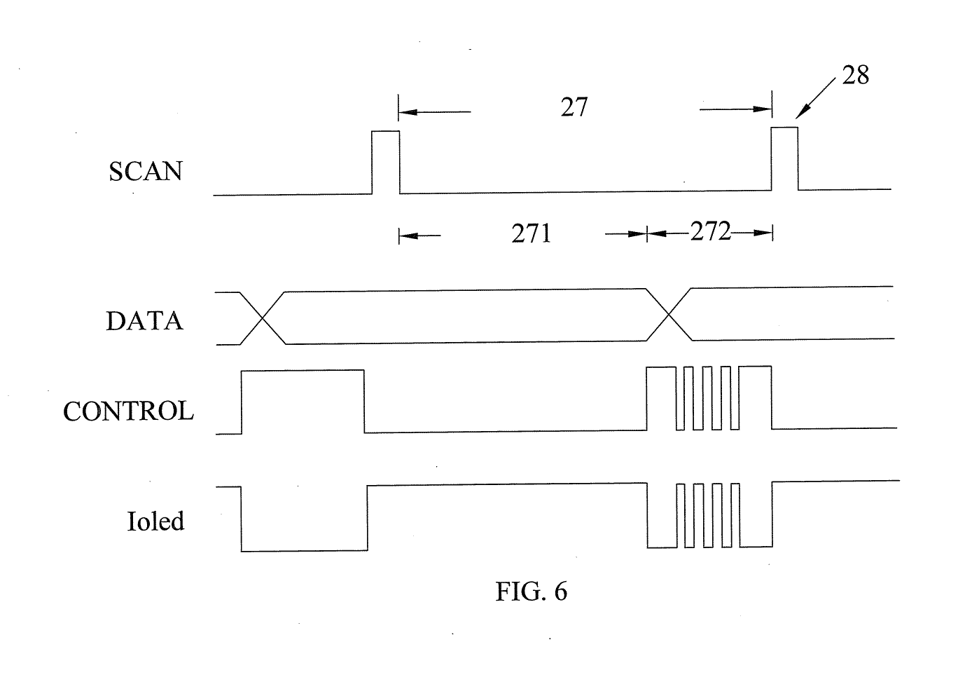

In the second embodiment, a parallel connection with a new path is provided to prevent the I_{oled} from flowing toward the OLED; however, even though the display designer uses this method to decrease the current flowing toward the OLED but not to cause the current to be zero so that the luminous intensity of the OLED during the interval 272 is reduced, this method is included within the protection scope of the present invention; alternatively, if a successive pulse is used as the control signal CONTROL during the interval 272 to adjust the luminous intensity of the OLED during the interval 272, as illustrated in FIG. 6, so that the luminous intensity of the OLED within the frame interval can be reduced without changing the original structure of the pixel unit, this method is also included within the protection scope of the present invention. The control signal illustrated in FIG. 6 can also be applied to the first embodiment.

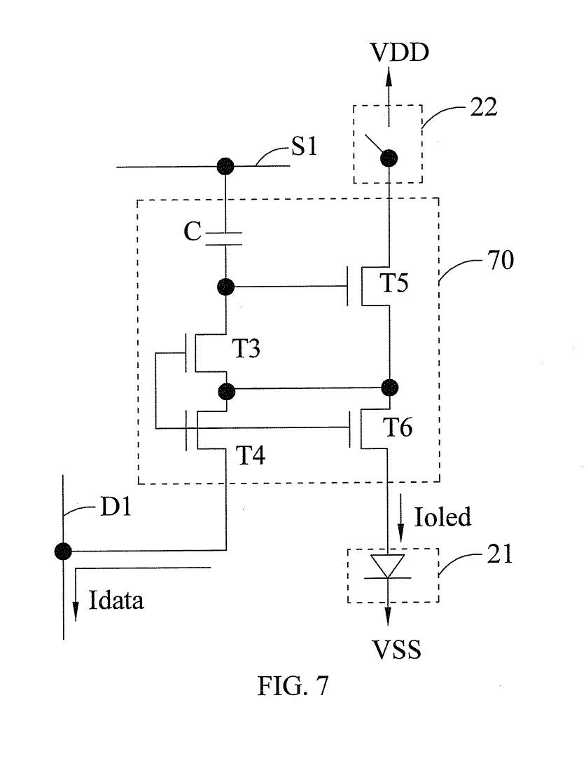

Referring to FIG. 7, there is illustrated a circuit diagram of a third embodiment of a pixel driving circuit of an organic light emitting diode according to the present invention. In this figure, the difference between the third embodiment and the first embodiment or between the third embodiment and the second embodiment is that the drive circuit 70 further comprises a current duplication circuit. In this embodiment, the current duplication circuit is comprised of transistors T3, T4, T5 and T6 for duplicating a current I_{data} flowing through the data line D1. Namely, I_{oled} is equal to I_{data}. Hence, the sensitivity of the I_{oled} in response to the transistor characteristics caused by the drift or variation of the manufacture processes can be decreased so as to improve the stability. The switch 22 is connected between the voltage source VDD and the drive circuit 70. The operation principle is the same as in the first embodiment and will be explained in no more detail. Moreover, the switch 22 is connected to the anode of the OLED 21 and the voltage source VDD. The operation principle is the same as in the second embodiment and will be explained in no more detail.

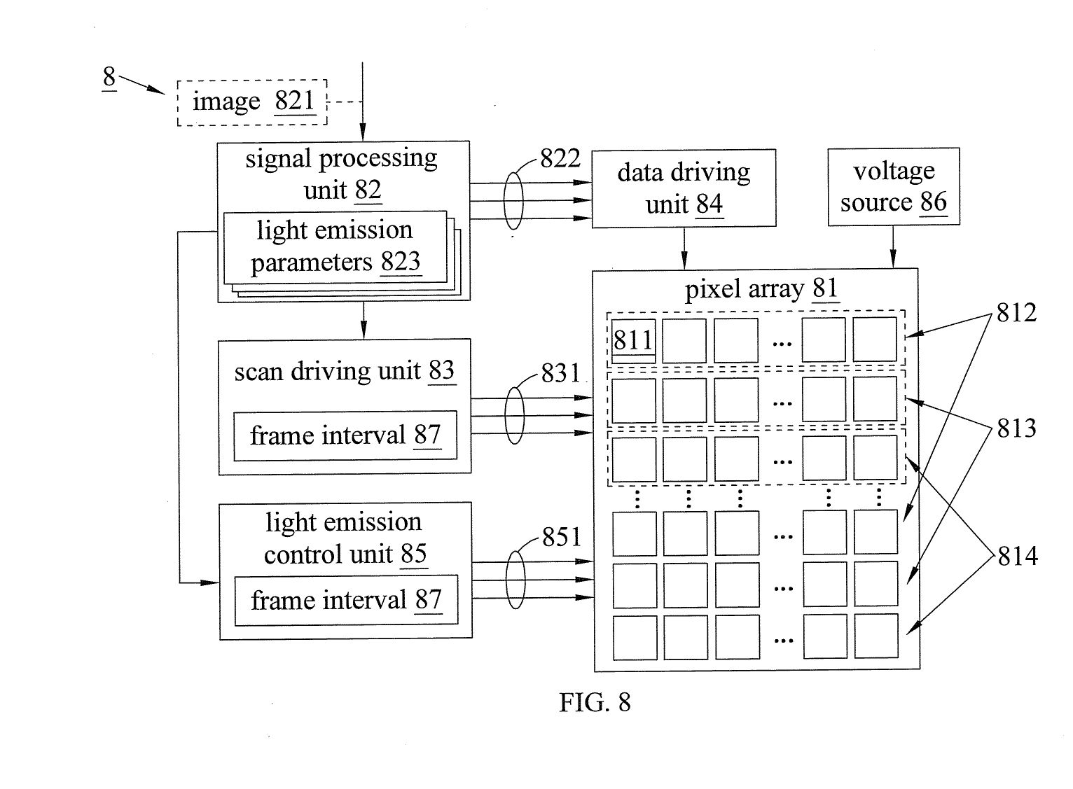

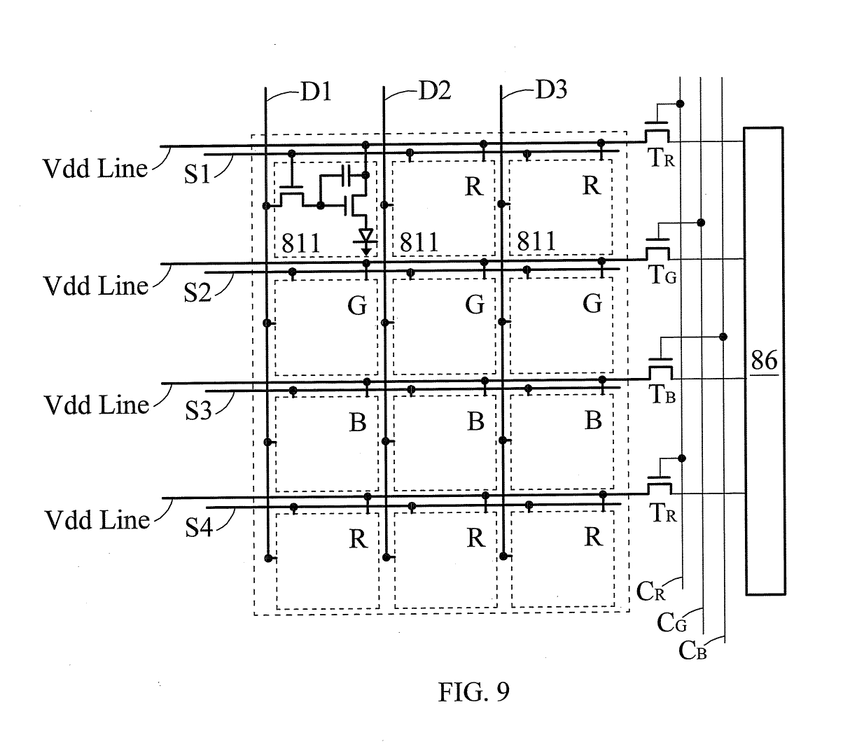

Referring to FIGS. 8 and 9, there are depicted a block diagram and a partial schematic view of a circuit of an organic light emitting diode display apparatus according to the present invention. In these figures, the organic light emitting diode display apparatus comprises a pixel array 81, a signal processing unit 82, a scan driving unit 83, a data driving unit 84, a light emission control unit 85 and a voltage source 86. The pixel array 81 comprises a plurality of pixel units 811 each having an OLED, and the plurality of pixel units 811 are divided into a plurality of pixel groups. Preferably, the plurality of pixel groups are pixel groups emitting light of different colors. Moreover, the plurality of pixel groups are preferably arranged in columns or rows. For example, in this embodiment, the pixel array 81 comprises red pixel groups 812, green pixel groups 813 and blue pixel groups 814, and their pixel units comprise a red OLED, a green OLED and a blue OLED, respectively. The pixels emitting in the same color are arranged in the same row. For example, a plurality of pixel rows emitting red light form red pixel groups 812 and a plurality of pixel rows emitting green light form green pixel groups 813. Also referring to FIG. 9, depicted is a pixel array 81 formed by a plurality of circuits of the first embodiment of the pixel unit illustrated in FIG. 2. The integrated switch of the pixel units 811 in the same row is implemented by a transistor T_{R}, T_{B} or T_{G} with no effect on its performance. The gates of the transistors T_{R}, T_{B} and T_{G} are respectively connected to control lines C_{R}, C_{B} and C_{G} for receiving corresponding control signals 851. A control signal 851 at a high potential or a low potential determines whether or not the current outputted from the voltage source 86 flows toward the pixel units 811.

The signal processing unit 82 receives an image 821 and generates a plurality of data signals 822 respectively corresponding to the plurality of pixel units 811 in accordance with the image 821. In this embodiment, the signal processing unit 82 generates red data signals, green data signals and blue data signals of the image 821. The signal processing unit 82 determines a plurality of light emission parameters 823 respectively corresponding to the plurality of pixel groups 812-814. The scan driving unit 83 generates a plurality of scanning signals 831 in accordance with the plurality of light emission parameters 823 and a frame interval 87 and drives the pixel array 81 in accordance with the plurality of scanning signals 831. The data driving unit 84 drives the plurality of pixel units 811 in accordance with the plurality of data signals 822.

Each scanning signal 831 includes a plurality of pulses, and two adjacent pulses define the frame interval 87. In FIG. 9, the pixel units 811 in the same row are connected to the same scanning line for receiving the scanning signals 831 and, for example, the pixel units 811 in rows 1 to 4 of the figure are connected to the scanning lines S1-S4, respectively; the pixel units 811 in the same column are connected to the same data line and, for example, the pixel units 811 in columns 1 to 3 of the figure are connected to the data lines D1-D3, respectively. When pulses appear in the scanning signal 831, i.e., shifted from a low potential to a high potential, the pixel unit 811 is in a state capable of receiving data signals and the data signals 822 on the data lines D1-D3 can be stored in the pixel units 811. The pulses of the plurality of scanning signals 831 are asynchronous with each other and can sequentially activate the pixel units 811 indifferent rows. The data driving unit 84 changes the data signals with pulse variations in the scanning signals 831. Hence, different data can be stored in the plurality of pixel units 811 within the pixel array 81.

The light emission control unit 85 generates a plurality of control signals 851 in accordance with the plurality of light emission parameters 823 to control the respective light emission time of the plurality of pixel groups within the frame interval 87. In FIG. 8, when the control signal 851 on the control line C_{R} is of a high potential, the transistor T_{R} is turned on and the pixel units within the red pixel groups can receive a current I_{OLED} outputted from the voltage source VDD; on the contrary, when the control signal 851 on the control line C_{R} is of a high potential, the transistor T_{R} is turned off and the pixel units within the red pixel groups cannot receive a current I_{OLED} outputted from the voltage source VDD so that the red OLED does not emit light. Preferably, the light emission parameter 823 is a ratio value of a light emission interval or a non-light emission interval within the frame interval 87, or time length of a light emission interval within the frame interval 87. The signal processing unit 82 analyzes a gray scale distribution of the image 821 corresponding to the pixel groups 812-814 and determines light emission parameters 823 corresponding to the pixel groups 812-814 in accordance with the gray scale distribution.

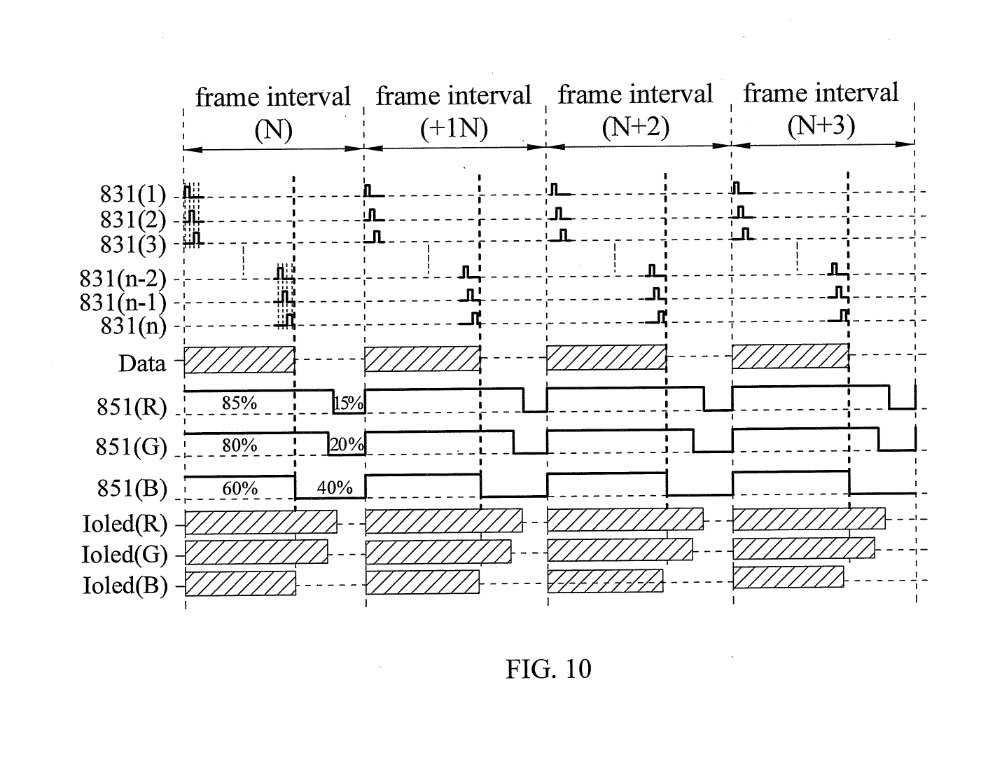

The scan driving unit 83 can adjust the positions of pulses in the scanning signal 831 in accordance with the light emission parameters 823. Continuing referring to FIG. 10, there is depicted a signal timing sequence diagram of an embodiment of an organic light emitting diode display apparatus according to the present invention. In this figure, 831(1), 831(2) to 831(n) are the scanning signals 831 respectively used in row 1, rows 2 to n. 851(R), 851(G) and 851(B) are control signals respectively used in red, green and blue pixel groups. In this figure, the time that the control signal 851(R) is at high potential is 85% of the corresponding frame interval (light emission interval), and the time that the control signal 851(R) is at low potential is 15% of the corresponding frame interval (non-light emission interval) within the corresponding frame interval; the time that the control signal 851(G) is at high potential is 80% of the corresponding frame interval (light emission interval), and the time that the control signal 851(G) is at low potential is 20% of the corresponding frame interval (non-light emission interval) within the corresponding frame interval; the time that the control signal 851(B) is at high potential is 60% of the corresponding frame interval (light emission interval), and the time that the control signal 851(B) is at low potential is 40% of the corresponding frame interval (non-light emission interval) within the corresponding frame interval. The scan driving unit 83 can shorten pulse intervals between the plurality of scanning signals 831 in accordance with the signal features of the above-mentioned plurality of control signals 851 so that the pulses of the scanning signals 831 can appear in the light emission interval. By this way, the second interval corresponding to the plurality of pixel rows of the pixel array is synchronous. Similarly, if the pixel groups of the pixel array are formed by a plurality of pixel columns, the same method is used so that the second interval corresponding to the plurality of pixel columns of the pixel array is synchronous.

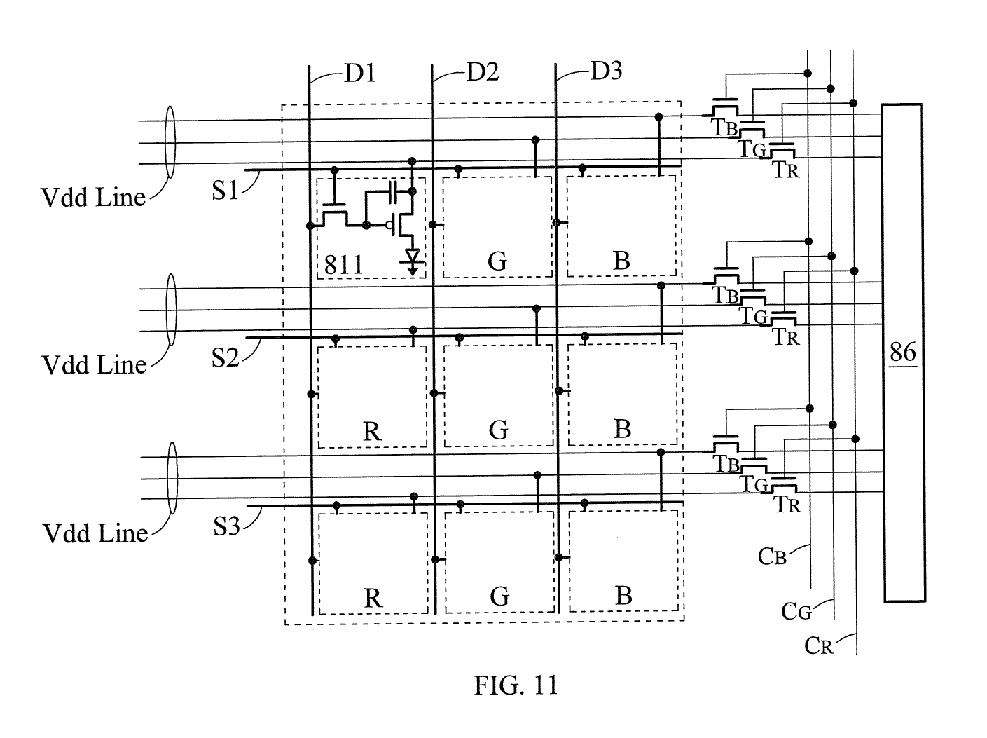

Referring to FIG. 11, there is depicted a schematic circuit diagram of a second embodiment of an organic light emitting diode display apparatus according to the present invention. In this figure, the difference between the second embodiment and the first embodiment is that the pixel units 811 of the same color are disposed in the same column. The operation principle is the same as in the first embodiment and will be explained in no more detail.

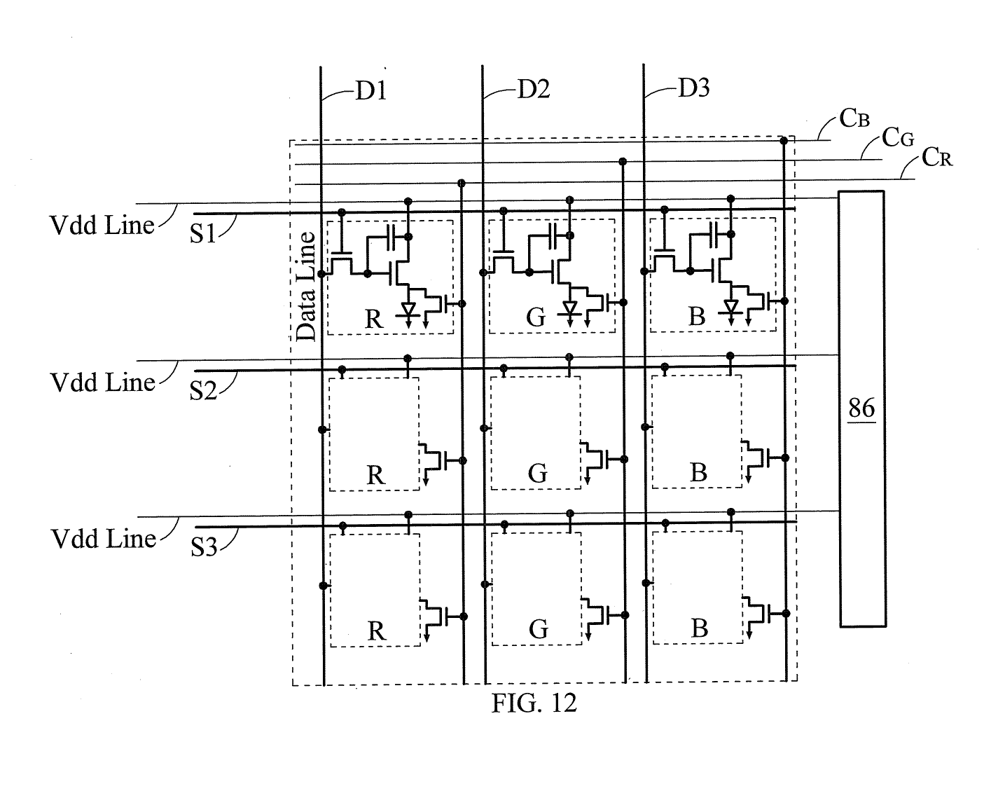

Referring to FIG. 12, there is depicted a schematic circuit diagram of a third embodiment of an organic light emitting diode display apparatus according to the present invention. In this figure, the difference between the third embodiment and the foregoing two embodiments is that the structures of the pixel units are different. The circuit illustrated in FIG. 12 is formed by the pixel units illustrated in FIG. 4. The operation principle has been described above and will be explained in no more detail.

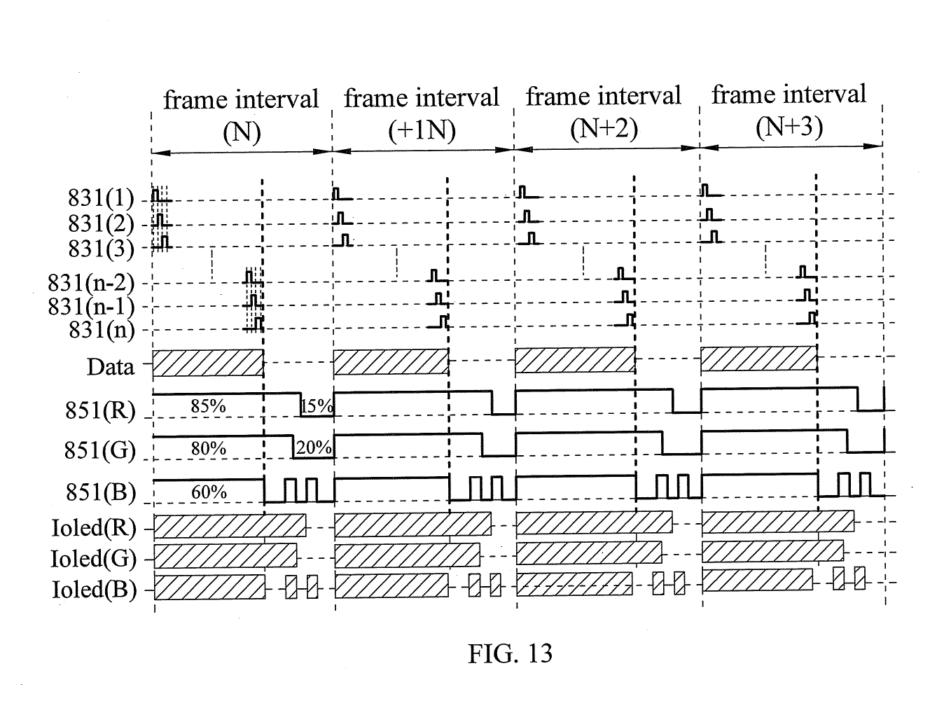

Referring to FIG. 13, there is depicted a signal timing sequence diagram of another embodiment of an organic light emitting diode display apparatus according to the present invention. In this figure, the difference between this timing sequence diagram and the timing sequence diagram of FIG. 10 is that the control signal 851(B) has a plurality of pulses in the non-light emission interval so as to adjust the blue light emission effect of the display apparatus.

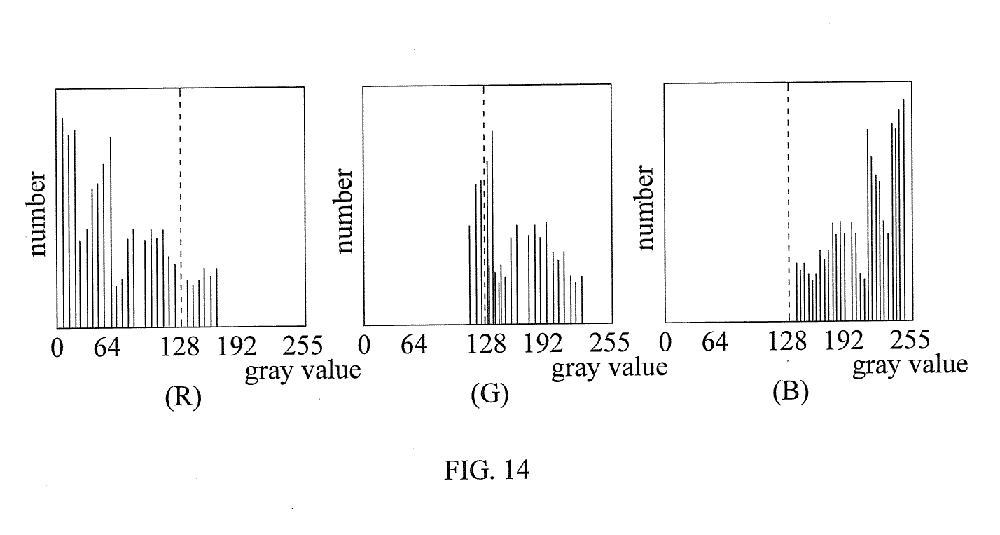

The light emission parameters of each pixel group can be determined after the signal processing unit 82 analyzes the content of an image. Since the purpose of shortening the light emission time of the OLED 21 within the frame interval is to prevent the OLED 21 of a specific color from fast degradation due to excessive light emission, the signal processing unit 82 can analyze a gray scale distribution of different colors in the image 821. When the amount of one color used exceeds a threshold value, the signal processing unit 82 will set a ratio value of a light emission interval or a non-light emission interval within the frame interval 87. The ratio value is used as the light emission parameter 823. The scan driving unit and the data driving unit 84 make a corresponding adjustment in accordance with the light emission parameter 823. Referring to FIG. 14, there are depicted gray level histograms for the red, green and blue colors of an image. As can be seen from this figure, the number of green pixels in the image with a gray value greater than 128 exceeds 50%, and the number of blue pixels with a gray value greater than 128 exceeds 50%. This analysis indicates that the display of this image needs to drive the green OLED and the blue OLED to emit higher intensity light, which results in serious consumption and accelerated degradation of light emitting units of these two colors. Therefor, the signal processing unit 82 sets the light emission parameters 87 corresponding to the green pixel groups and the blue pixel groups to activate the function of shortening the light emission time of the OLEDs, so that the control signals 851(G) and 851(B) have 20% and 40% non-light emission intervals within the frame interval, as illustrated in FIG. 10. Since the service life of a current blue OLED is shorter than that of a red OLED or a green OLED, the control signal 851(B) has a longer non-light emission interval.

Moreover, it can be determined whether the function of shortening the light emission time of the OLEDs is activated or not by a set mode inputted by the user and the content of an image. The signal processing unit 82 can analyze the image content to determine the respective ratios of the red, green and blue colors of the image content, and determine whether or not to activate the function in accordance with a query table of the corresponding relationship between recorded image contents and set modes, as set forth in Table I. If the user sets the OLED display apparatus to the persistent mode, it means that the user hopes to prolong the service life of the display. Accordingly, in Table I, if the ratio of the red content of an image exceeds 60%, or the ratio of the green content exceeds 30%, or the ratio of the blue content exceeds 10%, the above-mentioned function of shortening the light emission time of the OLEDs is activated. After the activation is determined, the light emission parameters can be determined in accordance with the gray scale distribution of each color. Since the service life of a current blue OLED is shortest, the activation values for the blue color in Table I is lowest.

TABLE I

| | ratios of R/G/B | | | | |
|---|---|---|---|---|---|
| set mode | red | | green | | blue |
| persistent | >60% | or | >30% | or | >10% |
| mode | | | | | |
| balanced | >30% | or | >30% | or | >30% |
| mode | | | | | |
| energy- | >10% | or | >10% | or | >10% |
| saving | | | | | |
| mode | | | | | |

Moreover, in order to reduce the influence of the shortened light emission time of OLEDs on the visual perception of the user in the above-mentioned embodiments, the signal processing unit 82 can compensate for the image 821 in a manner to appropriately increase the brightness of specific colors in the image, for example, to adjust the blue gamma curve or the green gamma curve of the image.

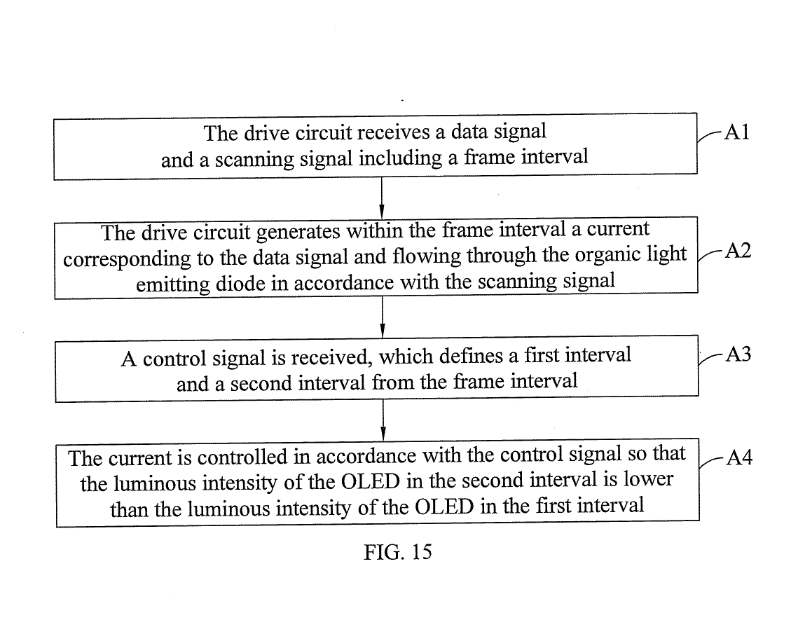

Referring to FIG. 15, there is depicted a flow chart illustrating a driving method for an organic light emitting diode display according to the present invention. A pixel unit of the organic light emitting diode display has an organic light emitting diode and a drive circuit. The drive circuit is connected to the organic light emitting diode. In this figure, the drive circuit receives a data signal and a scanning signal including a frame interval in step A1. In step A2, the drive circuit generates within the frame interval a current corresponding to the data signal and flowing through the organic light emitting diode in accordance with the scanning signal. In step A3, a control signal is received, which defines a first interval and a second interval from the frame interval. In step A4, the current is controlled in accordance with the control signal so that the luminous intensity of the organic light emitting diode in the second interval is lower than the luminous intensity of the organic light emitting diode in the first interval.

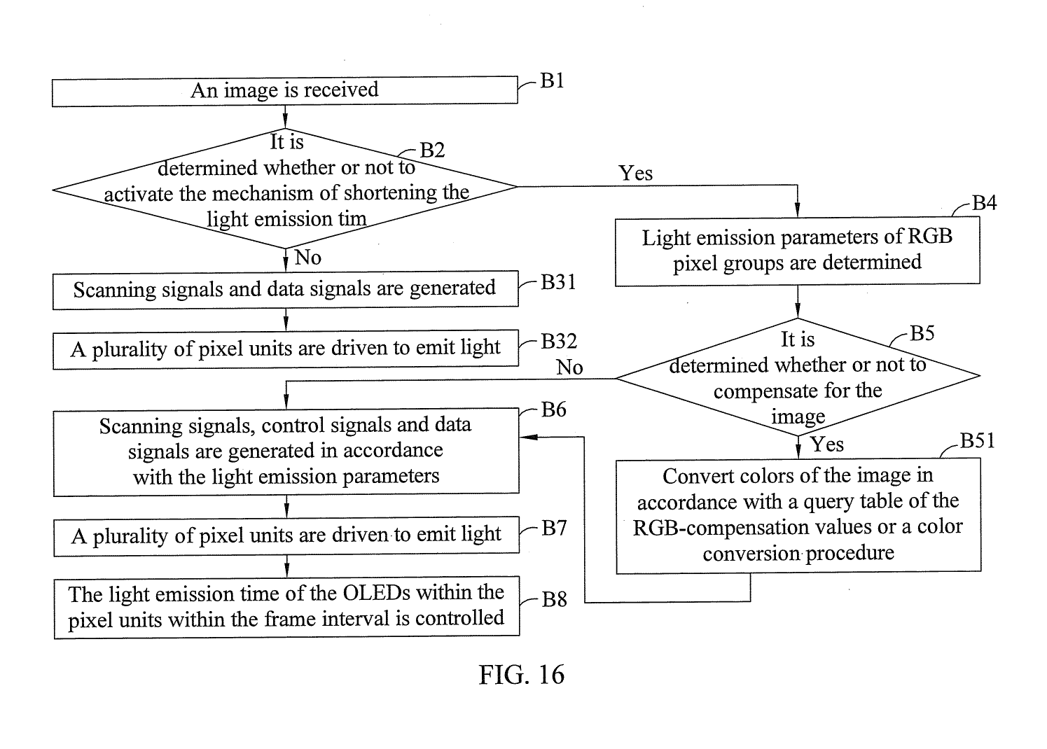

Referring to FIG. 16, there is depicted a flow chart illustrating the implementation of a driving method for an organic light emitting diode display according to the present invention. In this figure, the implementation procedure comprises the following steps. In step B1, an image is received. In step B2, gray scale distributions of the RGB colors of the image are analyzed and it is determined whether or not to activate the mechanism of shortening the light emission time. If no, step B31 is performed. If yes, step B4 is performed. In step B31, a plurality of scanning signals are generated, and a plurality of data signals are generated in accordance with the image. Next, in step B32, a plurality of pixel units within a pixel array are driven in accordance with the scanning signals and the data signals so as to emit light and display the image.

In step B4, light emission parameters of red, green and blue pixel groups, such as the ratio of the light emission interval or the ratio of the non-light emission interval within the frame interval, are determined. In step B5, it is determined whether or not to compensate for the image in accordance with the gray scale distributions of the RGB colors. If no, step B6 is performed. If yes, a query table of the RGB-compensation values is read or a color conversion procedure is performed to convert colors of the image in step B51. Step B6 is performed after the conversion. In step B6, a plurality of scanning signals and control signals are generated in accordance with the light emission parameters and the frame interval, and a plurality of data signals are generated in accordance with the original image or the converted image. In step B7, a plurality of pixel units within a pixel array are driven in accordance with the scanning signals and the data signals so as to emit light. In step B8, it is controlled whether or not the OLEDs within the pixel units emit light within the frame interval in accordance with the control signals.

The pixel units of the display are arranged in an array. If the image is displayed only in a specific region of the display, this may result in serious consumption of OLEDs of a specific color. It is possible to perform the above-described action of shortening the light emission time of the pixel units corresponding to a specific color within the specific region via the above-described mechanism. The operation principle is similar to the embodiments described above, and will be explained in no more detail.

The above description is illustrative only and is not to be considered limiting. The method of controlling light emitting units or the method of adjusting display parameters can be used alone or in combination. Various modifications or changes can be made without departing from the spirit and scope of the invention. All such equivalent modifications and changes shall be included within the scope of the appended claims.

What is claimed is:

1. A driving method for an organic light emitting diode display, a pixel unit of the organic light emitting diode display having an organic light emitting diode and a drive circuit, the drive circuit being connected to the organic light emitting diode, the driving method comprising:
receiving a scanning signal and a data signal via the drive circuit and the scanning signal including a frame interval;
generating within the frame interval a current corresponding to the data signal and flowing through the organic light emitting diode in accordance with the scanning signal via the drive circuit;
receiving a control signal defining a first interval and a second interval from the frame interval; and
controlling the current in accordance with the control signal so that the luminous intensity of the organic light emitting diode in the second interval is lower than the luminous intensity of the organic light emitting diode in the first interval.

2. The driving method as set forth in claim 1, further comprising:
analyzing an image received by the organic light emitting diode display; and
determining a ratio value of the first interval or the second interval in accordance with the analytical result.

3. The driving method as set forth in claim 1, wherein when the number of the pixel units is plural and the plural pixel units are divided into a plurality of pixel groups, the pixel unit of the same pixel groups corresponds to the same ratio value of the first interval or the second interval.

4. The driving method as set forth in claim 3, wherein the plurality of pixel groups emit light of different colors, respectively.

5. The driving method as set forth in claim 1, wherein the scanning signal includes a plurality of pulses and the frame interval is between two adjacent pulses.

6. The driving method as set forth in claim 1, wherein when the number of the pixel units is plural and the pixel units form a pixel array, the second interval corresponding to the plurality of pixel rows or the plurality of pixel columns of the pixel array is synchronous.

7. The driving method as set forth in claim 1, wherein when the number of the pixel units is plural, the driving method further comprises:
choosing the pixel unit located within a specific region corresponding to a specific color; and
controlling the chosen organic light emitting diode so that the luminous intensity of the organic light emitting diode in the second interval is lower than the luminous intensity of the organic light emitting diode in the first interval.

8. A pixel unit comprising:
an organic light emitting diode;
a switch; and
a drive circuit coupled to the organic light emitting diode and the switch and receiving a scanning signal including a frame interval and receiving a data signal, the drive circuit generating within the frame interval a current corresponding to the data signal and flowing to the organic light emitting diode;
wherein the switch controls the current flowing toward the organic light emitting diode only in some intervals of the light emission interval.

9. The pixel unit as set forth in claim 8, wherein the drive circuit comprises a first transistor, a second transistor and a capacitor, the source of the first transistor being connected to a data line for receiving the data signal, the gate of the first transistor being connected to a scanning line for receiving the scanning signal, the source of the second transistor being connected to the anode of the organic light emitting diode, the gate of the second transistor being connected to the drain of the first transistor, both ends of the capacitor being respectively connected to the gate and the drain of the second transistor, and both ends of the switch being connected to the drain of the second transistor and a first voltage source.

10. The pixel unit as set forth in claim 8, wherein the drive circuit comprises a first transistor, a second transistor and a capacitor, the source of the first transistor being connected to a data line for receiving the data signal, the gate of the first transistor being connected to a scanning line for receiving the scanning signal, the source of the second transistor being connected to the anode of the organic light emitting diode, the gate of the second transistor being connected to the drain of the first transistor, the drain of the second transistor being connected to a first voltage source, both ends of the capacitor being respectively connected to the gate of the second transistor and the first voltage source, and both ends of the switch being connected to the source of the second transistor and a second voltage source.

11. The pixel unit as set forth in claim 9, wherein the drive circuit further comprises a current duplication circuit for duplicating a current flowing through the data line.

12. An organic light emitting diode display apparatus comprising:
a pixel array comprising a plurality of pixel units each having an organic light emitting diode, the plurality of pixel units being divided into a plurality of pixel groups;
a signal processing unit receiving an image and generating a plurality of data signals respectively corresponding to the plurality of pixel units in accordance with the image, and determining a plurality of light emission parameters respectively corresponding to the plurality of pixel groups;
a scan driving unit generating a plurality of scanning signals in accordance with the plurality of light emission parameters and a frame interval and driving the pixel array in accordance with the plurality of scanning signals;
a data driving unit driving the plurality of pixel units in accordance with the plurality of data signals; and
a light emission control unit generating a plurality of control signals in accordance with the plurality of light emission parameters to control the respective light emission time of the plurality of pixel groups within the frame interval.

13. The organic light emitting diode display apparatus as set forth in claim 12, wherein the plurality of pixel groups display different colors, respectively.

14. The organic light emitting diode display apparatus as set forth in claim 12, wherein the plurality of scanning signals correspond to the plurality of pixel columns or the plurality of pixel rows of the pixel array, respectively.

15. The organic light emitting diode display apparatus as set forth in claim 14, wherein each of the plurality of scanning signals includes a plurality of pulses and the frame interval is between two adjacent pulses.

16. The organic light emitting diode display apparatus as set forth in claim 12, wherein each of the light emission parameters is a ratio value of a light emission interval or a non-light emission interval of the pixel unit within the frame interval.

17. The organic light emitting diode display apparatus as set forth in claim 12, wherein the plurality of pixel units are the pixel units as set forth in any of claims 8 to 10 and the plurality of control signals are used for controlling the switches of the plurality of pixel units.

18. The organic light emitting diode display apparatus as set forth in claim 12, wherein the signal processing unit analyzes a gray scale distribution of the image corresponding to the plurality of pixel groups and determines light emission parameters corresponding to the plurality of pixel groups in accordance with the gray scale distribution.

19. The pixel unit as set forth in claim 10, wherein the drive circuit further comprises a current duplication circuit for duplicating a current flowing through the data line.
